(19) United States
(12) Patent Application Publication
(10) Pub. No.: US 2015/0277384 A1
(43) Pub. Date: Oct. 1, 2015

(54) Electronic Timepiece

(71) Applicant: BlackBerry Limited, Waterloo (CA)

(72) Inventors: Peter Mankowski, Waterloo (CA); Ryan Alexander Geris, Kitchener (CA); Dietmar Frank Wennemer, St. Agatha (CA); Aaron Robert Allen, Pembroke Pines, FL (US); Timothy Herbert Kyowski, Kitchener (CA)

(21) Appl. No.: 14/671,432

(22) Filed: Mar. 27, 2015

(30) Foreign Application Priority Data
Mar. 27, 2014 (CA) 2847645

(51) Int. Cl. G04B 47/06

(52) U.S. Cl. CPC G04B 47/063

(57) ABSTRACT

An electronic watch is provided in which multiple features of the watch with each other in at least one other display thereof such that the features are integrated with the module, band, and/or clasp.

### CROSS-REFERENCE TO RELATED APPLICATIONS

This application is a filing under 35 U.S.C. 119 which claims priority to Canadian Patent Application No. 2,847,645 filed on Mar. 27, 2014, by Peter Mankowski, et al., entitled “Electronic Timepiece” (48013-CA-PAT-4214-53400), which is incorporated herein by reference as if reproduced in its entirety.

### BACKGROUND

As electronic watches (sometimes referred to as “smart watches”) evolve and become more and more prevalent, there is continuous and extensive interest in a newer and better engineered electronic watch that is full of a multitude of components, capabilities or functions, and user cases (collectively, “features”). There is also a significant challenge to design this type of watch such that all of these features are placed in a limited space. As a result, existing architecture of a traditional electronic watch forcibly places all of these features together into a single space of the watch. For example, a main face, sensors, and a battery or batteries of the watch are generally loaded on or within a main body of the watch such that there is limited room for them. Also, notifications are typically received on the main body, and several security features are added to the watch as well such that energy requirements of the watch are becoming more demanding. Yet, this architecture, among other things, reduces a size of each battery to a point where the watch needs to be recharged multiple times during any given day. So, it should be appreciated that combining these features with each other while still meeting “space” requirements of the watch proves to be incredibly difficult. In fact, traditional methods of design of the watch cannot properly integrate all “feature” blocks or modules with each other without enlarging the watch to an impractical size.

Also, an electronic watch crosses over a boundary between a mechanical device with moving parts and an electronic device powered by battery. This crossover creates problems of integration. More specifically, to meet design specifications of various components, such as sensors, a display, and a clasp of the watch, for example, these elements should be blended with each other in one elegant functional module. Such an electronic watch does not exist today.

### BRIEF DESCRIPTION OF DRAWING

For a more complete understanding of this disclosure, reference is now made to the following brief description, taken in connection with the accompanying drawing and detailed description, wherein like reference numerals represent like parts.

FIG. 1 is a block diagram of an electronic timepiece according to an embodiment;

FIG. 2 is a schematic top view of the electronic timepiece;

FIG. 3 is a schematic assembly view of the electronic timepiece illustrating a first module, along with a main-source battery, of the timepiece being built into a side of a main body of the timepiece;

FIG. 4 is a schematic isolated view of a module of the electronic timepiece;

FIG. 5 is a schematic isolated view of a solar panel of the electronic timepiece;

FIG. 6 is a schematic bottom view of the electronic timepiece; and

FIG. 7 is a schematic assembly view of the electronic timepiece illustrating first and second clasp members of the timepiece.

### DETAILED DESCRIPTION

It may be useful to configure some components, capabilities or functions, and user cases (collectively, “features”) of an electronic watch (also referred to herein as an “electronic timepiece”) away from a main body thereof and partitioning or splitting an overall architecture of the watch into multiple multi-functional modules or distinct sections thereof. For example, such unloading and partitioning or splitting results in, for instance, a thinner face of the main body, more space in the main body for components, such as a printed circuit board (PCB) and/or at least one battery, for example, as well as more flexibility of industrial design of the watch. The watch, or timepiece, described herein includes various embodiments that provide desirable functional components, while improving aesthetic appeal to improve consumer satisfaction.

Toward that end, disclosed below and shown in the drawing are systems and methods of a sectional electronic watch. It should be understood at the outset that although example and illustrative implementations of at least one embodiment of the watch are disclosed, the systems and/or methods may be implemented using any number of forms and techniques, whether currently known or in existence. As such, the disclosure should in no way be limited to these implementations, but the disclosure may be modified to be within the scope of the claims appended hereto along with their respective full scope of equivalents.

Referring now to the figures, an electronic watch according to an embodiment is generally indicated at 10. Concepts described in detail below may be applied with a variety of devices such that the concepts are not restricted to their application with the watch 10. The watch 10 includes data-communication capabilities and, as such, may communicate with other electronic devices directly or through a wireless network. The watch 10 also is based upon a computing environment and functionality of a handheld computer.

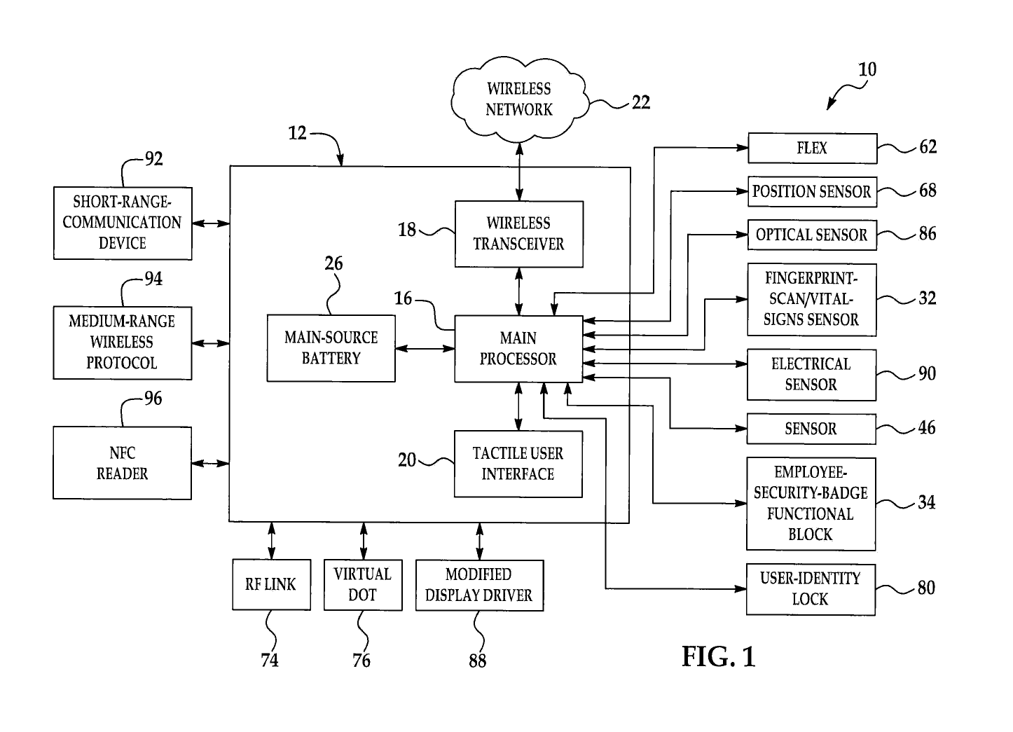

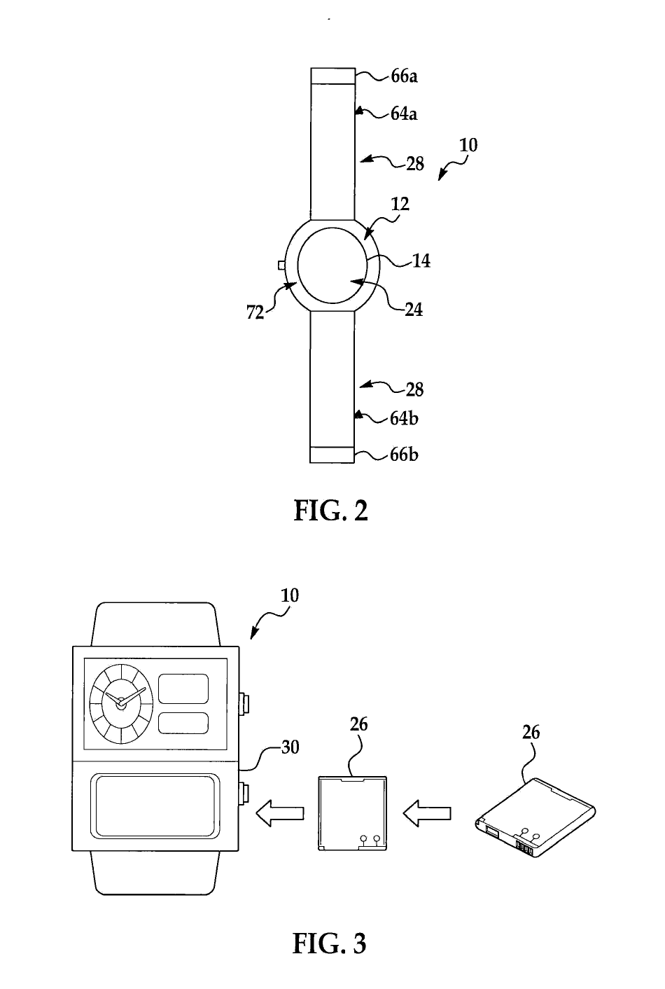

As shown in FIGS. 1 and 2, an embodiment of the electronic watch 10 includes a main body, generally indicated at 12, which, in turn, can include a housing (not shown) and defines a main face 14 of the watch 10. The main face 14 acts as a primary display of the watch 10. A main processor 16 is coupled to the main body 12 and in communication with various components and controls overall operation of the watch 10. It should be appreciated that, although identified for simplicity as a single unit, the main processor 16 can be embodied as a plurality of processors, wherein each processor is in communication with at least one component and/or controls (or participates in control of) at least one operation of the watch 10. A wireless transceiver 18 and tactile user interface 20 are coupled to the main body 12 and in communication with the main processor 16. The wireless transceiver 18 is configured to connect to a wireless network 22 and provides communication between the main processor 16 and wireless network 22. Examples of the wireless network 22 include, but are not limited to, the internet, a wide-area network, a local-area network, a satellite network, a telecommunications network, a private network, and any combination of these. Information can be sent from the wireless network 22 to a computing device (not shown), such as at least one server and/or processor. The user interface 20 is configured to provide interaction between the watch 10 and a user thereof and may take a variety of forms, including, but not limited to, a touchpad or touchscreen. The user interface 20 is sufficiently sized to track a finger of the user for detecting inputs in the form of taps, touches, swipes and gestures to execute watch functions.

A first module, generally indicated at 24, of the watch 10 is placed or resides at the main body 12 and includes the main processor 16 and at least one high-capacity, replaceable, sectional main-source battery 26. The main-source battery 26 is coupled to the main body 12 and in communication with, and provides power to, the main processor 16 and other components of the watch 10, as described below. A strap or band, generally indicated at 28, is coupled to the main body 12 and configured to wrap around a wrist of the user and be secured thereto to secure the watch 10 to the user.

In an implementation and as shown in FIG. 3, the first module 24 (FIG. 2), along with the processor 16 and main-source battery 26, is built into a side 30 of the main body 12. This implementation takes the main-source battery 26 outside of space defined by a bottom of the main body 12 and mounts the main-source battery 26 next to that space on the side 30, which provides a large energy compartment hidden from view of the user. This compartment, in turn, allows the main-source battery 26 to be other than of a “coin” type, which can permit greater energy density, capacity (e.g., 1018 mAh), security, and easy recharging and replacement of the main-source battery 26. A fingerprint-scan/vital-signs sensor 32 (FIG. 1) and employee-security-badge transmitter or functional block 34 (FIG. 1) can be included in the first module 24 as well.

In an example design, the fingerprint-scan/vital-signs sensor 32 is a CMOS-based module 32 with a metal frame to create capacitive load during a scan of a fingerprint or vital sign of the user. Upon installation of an infrared-based (IR-based) light-emitting diode (LED) and by pressing on a surface of the sensor 32, the sensor 32 is also capable of sensing and provides vital signs—e.g., a heart rate, level of oxygen, pulse, blood pressure, perspiration level, etc.—of the user simultaneously. The sensor 32 also can come in any of several optional sizes and colors matching those of the watch 10.

Also in the example design, the employee-security-badge functional block 34 is loaded with information (e.g. employee access credentials) via the network 22 and provides an easy replacement for a traditional “around-the-neck badge” tag. All information contained in the employee-security-badge functional block 34 follows the watch 10. Respective methods in connection with swipes, access levels, and location tags of the watch 10 may be similar or identical to those of a traditional tag.

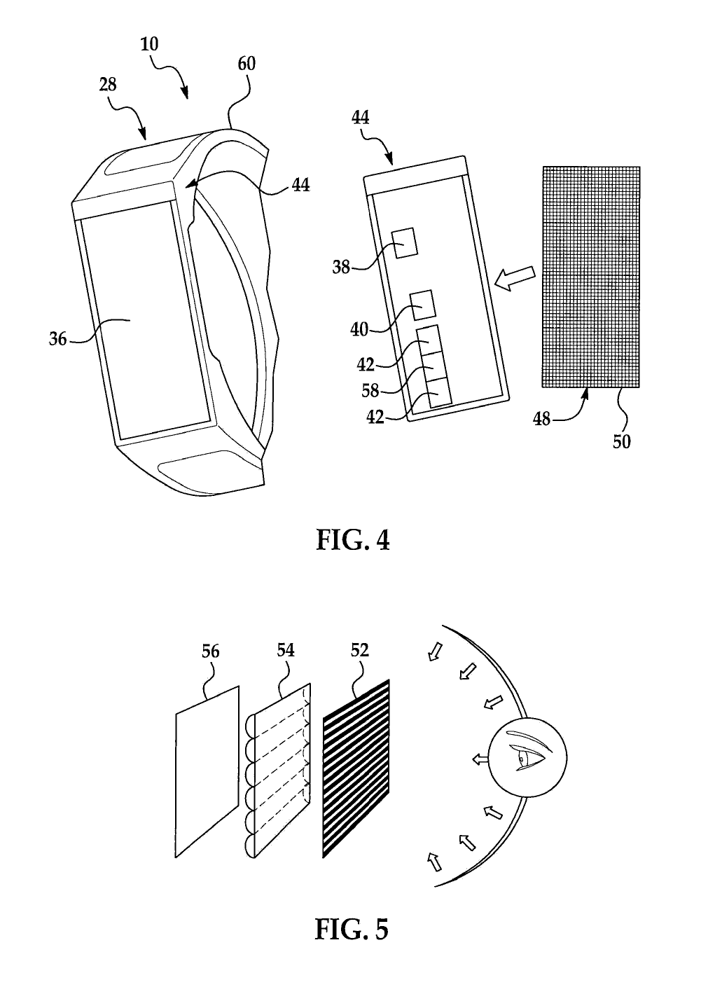

In another implementation and as shown in FIGS. 4 and 5, the band 28 is flexible and highly transparent and used as a platform to merge multiple other features of the watch 10 with each other in another space or display 36 of the watch 10. These features include, but are not limited to: a radio-frequency (RF) transceiver module and/or the antennas 38; capacitive-touch sensing of shapes, pressure, and movement forming a navigational hub 40; and at least one solar panel 42, of the watch 10. In one embodiment, all of these features are integrated with the band 28. In alternate embodiments, one or more of these components may be located at other portions of the watch 10.

In an exemplary design, the display 36 is transparent and encapsulated inside of a plastic frame, which may include curved and/or planar portions, generally indicated at 44, and includes a sensor 46. The display 36 is plastic as well such that WiFi, “BlueTooth,” and capacitive-loaded touch can perform their respective functions properly. The antennas 38 are highly integrated in the frame 44 such that the frame 44 serves as cargo space for the antennas 38 that encapsulates RF portions of the design. A large area defined by the frame 44 may be useful for spread of the antennas 38 in the frame 44, which, in turn, leads to better communication functionality of the watch 10 due to resulting additional volume of metal from the antennas 38.

For the “capacitive-touch sensing” feature, a capacitive-touch sensor “X-Y” grid, generally indicated at 48, is encapsulated in the display 36 and is constituted by a vertical/horizontal array of wires 50 which define the grid 48. The grid 48 in cooperation with the processor 16 is configured to detect contact by a finger of the user on a surface of the display 36 and, based upon results of the detection, activates or enables a specific “mode of operation” (e.g., music or telephone) of the watch 10 in real time. This arrangement allows for sensing various aspects associated with contact of an object with the surface of the display 36. The sensing may pertain to shapes of respective objects (like fingers of the user), movement such as swipes, circular motion, gestures and tapping (used as a navigational engine to control and manipulate functions of the watch 10, and capacitive touch applicable for use of features such as a volume slider, a button or buttons for simple navigation (“PLAY,” “PAUSE,” START,” etc.), and a simple touch controller. These sensing features are merely examples and are not intended to be an exhaustive list of the sensing capabilities of the grid 48.

All of these features may be enabled simultaneously in a non-intrusive manner. More specifically, each finger of the user defines a unique thickness and pressure “X-Y” distribution regions of the finger, which translates into the finger being a non-intrusive individual navigational device. Touch and movement of the user while he/she is touching the display may be translated into a virtual map.

Since the watch 10 is usually worn about the wrist (and not in a pocket) of the user and, hence, exposed to ambient light, there is a potential for the watch 10 to gather solar energy. In certain instances when the main face 14 may not have a surface area to harvest sufficient solar energy in order to power the watch 10 and/or recharge the battery 26, the band 28 may be additionally or alternatively configured with a solar panel. Toward this end, the solar panel 42 defines a high level of transparency and is designed as a module overlayed at a top of the display 36. The solar panel 42 also can include a photovoltaic solar cell or photovoltaic cells 52 (FIG. 5) configured atop a lens surface 54 that is constituted by semi-cylindrical portions, for example. In this way, the user can observe an image 56 that lies directly and immediately beneath the lens surface 54. The module 42 can be integrated onto any type of liquid-crystal display (LCD) (e.g., emissive or reflective) without any detrimental impact on functionality of the display 36 (e.g., touchscreen, display emission, and contrast). Furthermore, the design can enhance an angle of view of the display 36 if such enhancement is needed.

Alternatively, the solar panel 42 is combined with at least one flexible battery 58 cell or battery 26 within links 60 of the band 28. More specifically, each of a plurality of solar panels 42 is flexible, configured on a solid or pliable surface of an outside of the band 28, and sandwiches respective layers of a plurality of batteries 58. The batteries 58 are very thin and can be, for example, concatenated lithium cells. The batteries 58 can be stacked with each other to create an amount of energy in addition to the main-source battery 26. The band 28 is connected to the main body 12 via a flexible circuit board or flex 62, which provides a connection to a main circuit of the watch 10. With this design, integrated harvesting and storage of energy on the watch 10 is achieved.

In another implementation and as shown in FIGS. 1, 2, 6, and 7, the band 28 includes a first part, generally indicated at 64a, and second part, generally indicated at 64b. The first part 64a is coupled to and extends from a first area of the main body 12, and the second part 64b is coupled to and extends from a second area of the main body 12 opposite the first area.

A free end of the first part 64a of the band 28 includes a first clasp member 66a, and a free end of the second part 64b of the band 28 includes a second clasp member 66b. The clasp members 66a, 66b are engagable with one another to form a clasp, generally indicated at 66 (such as an invisible double-locking clasp 66), which locks or secures the clasp members 66a, 66b to each other to secure the band 28 and, thus, watch 10 around the wrist of the user. The clasp members 66a, 66b also may be engaged with one another to close a circuit defined by a voltage line and the main-source battery 26 and disengaged from one another to open the circuit and power off the watch 10.

In an example design, the clasp 66 includes or is engaged with at least one electrical position sensor 68 that detects displacement of the parts 64a, 64b relative to each other. The position sensor 68 is in communication with the main processor 16 and senses when the clasp 66 is in an “open” position or a “closed” position. The position sensor 68 notifies the main processor 16 of status of the clasp 66 as “open” or “closed” and any change in such status. As described in detail below, such notification can allow a secure method of knowing any change in use of the watch 10 by another user thereof. The watch 10 may be powered off or otherwise configured by the processor 16 in a standby or low power state when the clasp 66 is in the “open” position. The position sensor 68 may additionally control information displayed on the main face 14.

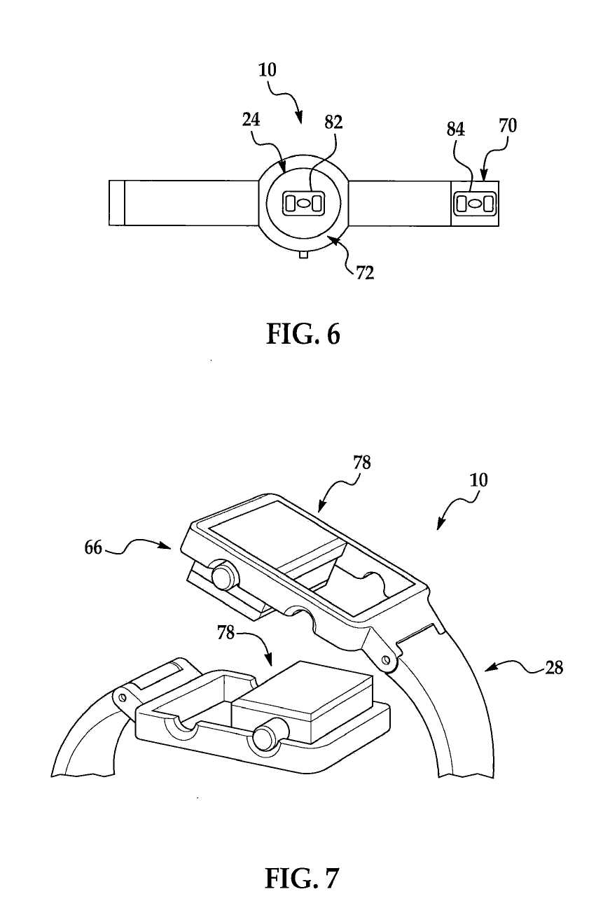

A second module, as shown in FIG. 6 and generally indicated at 70, of the watch 10 is placed or resides at the clasp 66. The second module 70 is placed away from the main face 14. Having both mechanical and electronic components, the second module 70 is supplied with energy from the main-source battery 26. Communication between the modules 24, 70 is achieved by use of “I2C” and “SPY” interfaces.

Each of the modules 24, 70 may take a variety of forms. By way of non-limiting example, the module 24, 70 may be an LCD. Alternatively, a translucent LCD may be used without backlighting. Further yet, smart glass may be used, and the module 24, 70 may be illuminated using a frost acting as a diffuser. Additionally, use of ambient light or LEDs on the edge of the module 24, 70 for illumination and/or organic LEDs (OLEDs) can be included.

In a particular arrangement, the first module 24 may include a first touchpad, and the second module 70 may include a second touchpad opposite the first touchpad. Locating the first and second touchpads on opposite sides of the watch 10 may generally provide a greater surface area for a tactile-based user interface and support “touchpad” functions—including, but not limited to, pinch, stretch, scroll, and tap “up”/“down” on a platform with space available for input of the user. As described below, the main processor 16 coordinates inputs between the first and second touchpads relative to one another to accommodate these functions. In an alternative arrangement, at least one of the modules 24, 70 may include an additional display with or without touchscreen functionality and/or a decorative component. By way of illustration only and with respect to specifically the clasp members 66a, 66b of the second module 70, a first touchpad can be located on the first clasp member 66a, and a second touchpad can be located on the second clasp member 66b. By way of non-limiting example, the decorative component may be a lighted component, such as an LED powered by the main-source battery 26.

In another alternative arrangement, the main body 12 may include a bi-directional rotating bezel, generally indicated at 72, having a conductive surface in communication with the main processor 16 that provides another tactile-based user interface—i.e., input to the main processor 16 for performance of additional functions. More specifically, the traditional watch with a rotating bezel is a single-purpose device. To wit, the conventional rotating bezel is used for merely a function called “worldtimer” (i.e., the bezel displays twenty-four different time zones and, thus, can display current time in any part of the world), and time-zone selection is the only function associated with the bezel. In other words, there is no intelligent interaction between the watch and any other mobile device attached to the watch to make it useful.

However, with the watch 10, the bezel 72 is used as a control-and-mode-selection navigational hub 72 for the purpose of allowing the user to interact with the watch 10 or extend the watch 10 to any other mobile device with, for instance, a “BlueTooth” low-energy (BTL) standard RF link 74. There are three main modes of operation: 1) “LOCAL” (in which the bezel 72 is exclusively used to navigate inside the user interface 20); 2) “M2M pairing” (in which the watch 10 and any other mobile device are paired with each other via BTL and blend their respective functions together, wherein the bezel 72 controls both the functionality of the watch 10 and other mobile device such as a smartphone or tablet in real time); and 3) “secure-network connected” (in which the bezel 72 is registered on the wireless network 22 beyond the watch 10 to the M2M pairing).

In the “secure-network connected” mode, the user can navigate, control, and become a virtual master to other devices present on the network 22—e.g., CDMA, LTE, WiFi, BTL, and WiMAX. Also, this mode can be expanded to a bi-directional-communication interaction, wherein: 1) The user rotates the bezel 72 to a required mode or control call; 2) A trusted device and/or the user anywhere on the wireless network 22 are/is capable of remotely interrupting movement of the bezel 72, whereby a custom configuration part provides flexibility to replace traditional alarms and notifications by virtual rotational movement of the bezel 72; and 3) For example, a “position” cursor (such as a red dot) rotates at a predefined speed while a new notification arrives.

Still, a user reference regarding position of the bezel 72 may be helpful, such as a virtual dot (“user interface” software) 76. With the virtual dot 76, the user simply moves the dot around an outside of the main face 14 by a swipe or gesture on the user interface 20 to select a desired mode of operation of the watch 10—e.g., related to time, biometrics, work mail, personal mail, call, audio/volume control, password, internet, weather, dictionary, meetings, sticky note, or custom.

In the illustrated embodiments, some of the components are placed at the clasp 66 (i.e., proximate the back of the wrist) and the watch 10 is configured to provide notification of the “open/closed” status of the watch 10. In this way, each of the main body 12, main face 14, modules 24, 70, main-source battery 26, main processor 16, band 28, and sensors 32, 46, 68 can have any suitable size, shape, and structure and can have any suitable relationship with a remainder of the watch 10. It should be appreciated also that the clasp 66 can be any suitable clasp and can secure the watch 10 around the wrist by various means. It should be appreciated also that the sensor 68 can notify the main processor 16 of the “open/closed” status, the second module 70 can be supplied with energy, and communication between the modules 24, 70 can be achieved by any suitable system, including a hardwired or wireless system. It should be appreciated also that each of the modules 24, 70 can include any suitable kind and number of features.

The second module 70 may be configured with a heart-rate monitor, secondary display, generally indicated at 78, for messaging, and user-identity lock 80. Each is discussed in turn in detail immediately below.

Traditional architecture of a hybrid watch/heart-rate monitor places all sensors of the monitor at a back of the main body of the watch mounted underneath the main face thereof. This design is based upon so-called “reflective infrared (IR)” properties and known for intermittent readings of a pulse of the user caused by human movement and poor contact with skin of the user. In this way, accuracy of the traditional monitor is low.

However, architecture of the present heart-rate monitor is partitioned into two distinct sections and based upon a “master/slave” structure and an ability to interrupt each of the modules 24, 70 with a very short “latency” flag. More specifically, instead of just a first unit 82 of the monitor installed proximate the first module 24, a second unit 84 of the monitor that may or may not be identical to the first unit 82 is installed at the second module 70 proximate the clasp 66. The second unit 84 may be located on or within the band 28 or the clasp 66. The first unit 82 and the second unit 84 each comprise at least one sensor or other vital sign monitoring assembly of components. Communication between the modules 24, 70 is achieved by using the “I2C” interface, which provides a link to the main processor 16. The watch 10 adds an electrical sensor that notifies the main processor 16 when the monitor needs to begin an initial “scan” sequence.

The monitor uses an optical sensor 86 placed under the wrist (instead of traditionally above the wrist) to measure a pulse and, in turn, heart rate of the user. In this way, there is better contact between the wrist and sensor 86 and opportunity for the sensor 86 to read the pulse. Also, more space is available for the sensor 86 since the monitor is located away from the main face 14. The monitor uses a “bottom/top hybrid IR” architecture with both “reflective IR” and “absorptive IR” methods to measure the pulse. In the “reflective IR” method, with aid of an IR diode and a photodiode, a signal—such as a green light—is emitted into skin of the user and reflects off a blood stream in veins and travels back to the sensor 86. In the “absorptive IR” method, a sensor 86 is required on each side of the wrist. The signal is transmitted through the user's wrist from one of the sides and arrives at the other side to be scanned. As the signal travels through the user, the signal becomes distorted, and an “S/N” ratio of the signal changes. To combine both techniques, the monitor is configured such that the sensors 86 are disposed respectively on both bottom and top of the watch 10. It should be appreciated that there are a plurality of modes of operation of the monitor—e.g., both of the sensors 86 are reflective or one of the sensors 86 is in “reflective” mode and the other sensor 86 is in “absorptive” mode and the sensors 86 alternate with each other over time. As a result, the monitor is hybrid, can use reflective and absorptive scans by interleaving them over a heart-rate-scan session, and operates in multi-mode by coordinating each of the sensors 86.

All components of the heart rate monitor assembly, including the first unit 82 and the second unit 84, as well as all associated sensors, may be in communication with each other and/or the main processor 16 via a wireless system or a hardwired system. In a hardwired embodiment, the components proximate the clasp 66 are hardwired to the main processor 16 via routing of wiring through the band 28. The monitor is highly efficient and more clearly reads the pulse. Also, the monitor allows scanning of oxygen levels in blood of the user and three-dimensional blood-distribution or heart-rate modeling or scanning, which provides greater, improved, and a very high level of accuracy and a continuous scan even if the band 28 slides or otherwise moves an excessive amount on the wrist (e.g., when the user is running). When the user is wearing the watch 10, weight of the watch 10 is distributed (by way of a “front-to-back” principle) and, therefore, the watch 10 feels extremely balanced to the user.

The secondary display 78 takes features away from the primary display 14 for simplicity and practicality. More specifically, the secondary display 78 is sectional such that the secondary display 78 includes at least two pieces, as shown in FIG. 7, placed over the clasp 66 and, thus, a back of the wrist. The primary display 14 displays a first set of content or information, and the secondary display 78 displays a second set of information different than the first set of information. For example, the primary display 14 may display information that is acceptable by the user for public viewing—such as time, date, temperature, and/or number of incoming messages in an e-mailbox of the user. The secondary display 78, in contrast, may display information that the user determines is private and, thus, not acceptable for public viewing, such as text of an e-mail message.

Distribution of the information between the two targets or functional pieces of the secondary display 78 is determined by the main processor 16. More specifically, a “deterministic” method controls, displays, distributes, manipulates, and shares content between the two pieces based upon human-movement-sensory profiling. Traditionally, by default, all notifications come to the primary display 14. However, this has a fundamental flaw if the user positions his/her hand in such way that the primary display 14 is not visible. Regardless of movement and current position of the watch 10, at least one of the displays 14, 78 must notify the user when a notification arrives. Toward that end, the watch 10 employs gravity and a sensory module or set of several built-in sensors such as gyroscopes, accelerometers and the like to address this problem.

In particular, as the user rotates or otherwise moves his/her hand or wrist, the set of sensors recognizes the movement and current position in real time and makes a decision as to which of the displays 14, 78 is going to be used. The decision is tightly coupled with arrival of each notification to preserve life of the main-source battery 26. As soon as this is established, the decision is based upon configuration and sensory ability of the watch 10 to recognize the movement and current position. In this way, an incoming message simply appears on the display 14, 78 that is easier to read under current conditions. This feature can be overridden by the user to edit a “profile” configuration in a “settings” portion of the watch 10. By default, the message appears on the display 14, 78 that faces the user at an angle that is better for allowing the message to be read.

An additional feature set of at least one of the displays 14, 78 is that it can be a “digital/analog” hybrid with “hour”/“minute” arms of the watch 10 having dynamically adjusted color and transparency characteristics. More specifically, with design of a traditional hybrid watch, a clock face thereof and its mechanical arms have the same “industrial” concept with respect to each other (i.e., aluminum plus metal arms). However, with the watch 10, analog “hour” and “minute” arms of the display 14, 78 are designed to be capable of features such as basic color change and regulated transparency of the arms. Both are possible as long as each arm is electrically connected to a modified display driver 88. Therefore, at any given time, the processor 16 and display driver 88 are capable of changing color of the arms and/or the main face 14.

As a result of this feature set, the user can experience several desired effects. By way of example, color of the main face 14 and arms can be synchronized with each other (thus, creating an illusion of a single entity thereof). So, if a current function of the watch 10 requires the mechanical arms to be invisible, then their transparency can be increased for an illusion of their not being there. In this way, the user is essentially under the impression that the arms disappeared (although, of course, they have not). Such transparency is particularly relevant when, for instance, an incoming text message arrives to the watch 10 and needs to be displayed to and viewed by the user, except for the arms are obstructing the view. Making the arms transparent for a predefined period of time provides a particularly unusual visual effect and allows the user to more easily read the message. Alternatively, as an opposite approach, a background of the main face 14 vis-à-vis the arms can be highlighted by two respective distinct color patterns thereof. By configuring the arms to be predominant to eyes of the user, the arms are made less transparent with any basic color overlay thereof. In this way, a color-plus-transparency pulse of one or both arms may be used for notifications of corresponding text messages sent to the watch 10 instead of an LED-based “color blink.”

In traditional form, locking mechanics of the clasp of the watch merely lock the band to secure the watch while it is being used. Yet, another function of the clasp 66 is security.

In particular, the user-identity lock 80 adds an electrical sensor 90 that notifies the main processor 16 of any changes in “OPEN”/“CLOSE” status of the watch 10. Electrical sensor 90 is similar to electrical sensor 68 described above, as they both detect whether the watch 10 is in an open or closed condition. Although illustrated and described as separate components, it is to be appreciated that a single sensor may be employed to communicate the status to the main processor 16 to facilitate multiple functions that are dependent upon whether the watch 10 is in an open or closed condition. For functions associated with security, user-identity locking may be based upon whether the watch 10 is worn or not or clasped or not. This is a secure method of knowing possible changes in ownership of the watch 10.

Also, the watch 10 can be used to unlock a portable electronic device—for instance, a mobile telephone—of the user. For example, if the user loses or misplaces both the watch 10 and telephone such that a third party comes into possession of them or the third party even steals them, the third party is unable to access the telephone by simply possessing the watch 10 since removal or unclasping of the watch 10 from the user disables ability of the watch 10 to unlock the telephone.

This “watch security” concept can be applied to other assets of the user. For example, in addition to the security given by the watch 10 to the telephone, the watch 10 can secure also an automobile. More specifically, a newer automobile uses wireless communication—e.g., radio-frequency identification (RFID)—between an electronic key (including a fob) of the automobile and the automobile itself to operate an ignition, door locks, a trunk, a glove compartment, and other components of the automobile. As such, a third party who possesses the key has full access to the automobile. With this concept, however, in addition to the key, the user has an additional security identifier in the watch 10. In particular, if the third party possesses the key, the automobile has limited functionality without the watch 10. For instance, unless the watch 10 is present, the ignition (and door locks, trunk, glove compartment, and other components) cannot be operated, and, thus, the automobile cannot be driven more than a set distance, such as 5 km (3.1 miles). Even if the watch 10 is present, removal or unclasping of the watch 10 from the user disables ability of the watch 10 to operate the components. Because the user can have less worry when the automobile is in control or possession by another, as is the case when the automobile is parked by valet (who cannot open the glove compartment or go for a “joyride”), the concept has applicability beyond deterring theft. In effect, the key is a “valet's key,” but becomes an “owner's key” when the watch 10 is present.

Accordingly, beyond functionality of its merely telling time, the watch 10 can provide automotive and portable-electronic-device security based on the watch's presence (or absence) and/or by removal/unclasping of the watch 10 from the user.

Further functionality of the watch 10 includes context awareness, wherein a “user interface” mode of the watch 10 can change based upon short-range identification of objects that are positioned within a certain distance of the watch 10. With this functionality, the watch 10 makes a handheld mobile device, such as a telephone, aware that a user thereof is holding in his/her hand an object—such as a mug, suitcase, wallet, etc. or even the telephone itself—and what hand is holding the object and what type of object it is or precisely what the object is (e.g., the user's mug). Although a telephone is used below as an exemplary one of the handheld mobile device, it should be appreciated that the handheld mobile device can be any suitable such device.

Representative scenarios in which this functionality may be useful include (but are in no way exclusively limited to): 1) The telephone determines a situation by being made aware that the user thereof is typing on a keyboard of the telephone with only a single hand because the other hand is busy, so the telephone adjusts the “entry” mechanism of the telephone appropriately by changing to a different typing mode that is more appropriate for single-handed on-the-go typing for instance, a “quick response” mode in which the user can select between different predefined phrases (e.g., “I'll be there in 5 minutes”) that are often better suited for quick single-handed responses; 2) The telephone discovers that the user is touching a steering wheel of an automobile, so the telephone disables all of its features except its basic “emergency call” feature; 3) The user is touching a knob of a locked door, so the door is unlocked upon authentication of the user; 4) The user identifies every object that the user picks up and tracks the object(s) or keeps a log thereof on the telephone that can be accessed therefrom later (for example, the user currently cannot find his/her set of keys, so the user inquires of the telephone for information related to the last time that the user was observed holding the set); 5) The telephone displays information pertaining to an object that the user is currently holding or touching (for instance, the user is touching a pole of a sign of a bus stop with his/her left hand, so a display of a bus schedule is triggered on the telephone that the user is holding with his/her right hand); and 6) In a collaborative environment, the respective telephones of a group of persons keep track of the person who last held an important shared object (say, a unique key to a secured file cabinet).

Toward this end, a short-range protocol in the form of a short-range-communication device 92 (e.g., an electromyography sensor having a range of about 10-18 cm) is embedded into or placed in the watch 10 and detects whether or not the user is holding an object in his/her hand. The watch 10 is paired with the telephone through a medium-range wireless protocol 94 so that they form with each other a body-area network with a range of about 2 m. If the short-range-communication device 92 embodied as an electromyography sensor detects that the user is holding an object, a “muscle activity” signature is recorded and contains a sufficient amount and kind of information for the watch 10 to deduce or discover and identify a type of object that is being held (for instance, whether the object is a mug, suitcase, wallet, etc.). Thereafter, the watch 10 keeps the telephone informed about what the user is holding.

The discovery and identification of the object in the user's hand is made possible by the use of the short-range-communication device 92. A multitude of objects today are already embedded with identification (ID) tags (such as RFID tags) for retail applications. This will be even more prevalent in the future and is likely to be present in consumer goods such as mugs, suitcases, wallets, key chains, door knobs, etc. Whenever the user picks up an object with an ID tag, the tag is read by the watch 10 and forwarded to the telephone via the medium-range wireless protocol 94. The user interface on the telephone can then adapt to change of context of the user. For example, upon being informed that the user has just picked up a mug, the user interface can switch to a keyboard that is more accommodating of single-handed typing. In one embodiment, the watch 10 is equipped with an optical device, such as a digital camera module, that is suitable for object identification.

The short-range protocol can take several forms. For example, in “capacitive communication,” a communication signal travels through the user's skin. As such, physical contact (or at least extremely close proximity) between the telephone and user's skin and between the watch 10 and user's skin are both required. To work in a capacitive manner, the watch 10 must also always be in electrical contact with the user's skin. With this form of the protocol, it can be substantially guaranteed that the user is really holding an object.

Alternatively, in “short-range wireless” communication such as “near-field communication” (NFC), the ID tag is communicated to the watch 10 as soon as the watch 10 and telephone are located sufficiently close to each other for an exchange of information between them to take place (about 10-18 cm). NFC is shorter range, and, thus, an NFC tag makes it easier to identify the object that is in the hand (possibly near an NFC reader 96 in the watch 10). Determination of direction of the read NFC tag may be possible using multiple readers 96 and triangulation while determination of distance of the tag may be determined by NFC signal strength in controlled circumstances. Also, determination of which hand is touching the object may be possible by using two readers 96 (say, one on each wrist). Determination of whether other portions of the user are touching the object may be possible if a set of readers 96 are dispersed about the user.

It should be appreciated that there may be less need for the watch 10 in this scenario if the telephone is in a pocket of the user and, thus, generally about 10-18 cm from the user's hand. However, since the telephone may pick up substantially everything within about 10-18 cm of the user, it may be difficult to determine what the user is actually touching without the watch 10.

Therefore, there is no need to explicitly scan the ID tag of an object since the ID tag is scanned automatically as the user is grabbing the object. A gesture of the user in his/her reaching for the object and grabbing it is deliberate and indicative of intent of the user to so reach and grab. Upon identification of the object, the user interface of the telephone changes state/mode to adapt to the change in the user context.

So, by use of the watch 10, the telephone can perceive its environment and the environment that the user is currently experiencing or tasks that the user is currently performing. Stated another way, the fact that the user is holding an object (e.g., a mug, a wallet, or even the telephone itself), doing something (e.g., touching a steering wheel and, thus, driving) or touching an object (a door knob) can inform the telephone of its current environment. Determination of the touched object is, along with aid from the watch 10 as an intermediary, by either capacitive or short-range-wireless means with a pre-existing ID tag embedded in the touched object. The telephone can adapt its interface or perform an interaction with an external device based on a perceived environment determined by the object that the user is touching. In other words, functionality on the telephone can then be adapted depending upon what the user is touching or holding, such as changing the telephone's user interface or authenticating with a door-locking mechanism to unlock a door the user is touching. Moreover, the telephone can advantageously also know what hand is being used to hold the telephone and/or touch the object, which can further inform the telephone of the current environment and tasks being performed by the user.

The preceding description describes in one embodiment an electronic timepiece including a main body that includes a main face having a primary display. Also included is a processor within the main body and operable to control the primary display. Further included is a band extending from the main body and configured to wrap around a wrist of a wearer. Yet further included is a clasp coupled to the band and configured to secure the main body to the wrist of the wearer. Also included is a secondary display proximate the clasp. Further included is a sensor proximate the clasp to detect a vital sign of the wearer, the sensor configured to communicate the vital sign to the processor.

The preceding description describes in yet another embodiment an electronic timepiece including a main body that includes a main face. Also included is a processor within the main body and operable to control the electronic timepiece. Further included is a band extending from the main body and configured to wrap around a wrist of a wearer. Yet further included is a clasp coupled to the band and configured to secure the main body to the wrist of the wearer. Also included is a first sensor located proximate the main body and configured to detect a vital sign of the wearer with a first detection mode. Further included is a second sensor located proximate the clasp and configured to detect a vital sign of the wearer with a second detection mode.

While implementations of systems and methods of at least one embodiment have been disclosed above and in the drawing, it should be appreciated that the systems and methods may be implemented in many other specific forms and techniques without departing from the spirit or scope of the disclosure. The implementations are to be considered as exemplary and illustrative and not restrictive, and the intention is not to be limited to the details given herein. For example, the various elements or components may be combined or integrated with another system, or certain features may be omitted or not implemented.

Also, systems (including sub-systems), modules, methods, and techniques disclosed herein as discrete or separate may be combined or integrated with other systems (including sub-systems), modules, methods, and techniques without departing from the scope of the disclosure. Other items disclosed herein as coupled or directly coupled or communicating with each other may be indirectly coupled or communicating with each other through some interface, device, or intermediate component, whether electrically, mechanically, or otherwise. Other examples of changes, substitutions, and alterations are ascertainable by one skilled in the art and could be made without departing from the spirit and scope disclosed herein.

1. An electronic timepiece comprising:
a main body that includes a main face having a primary display;
a processor within the main body and operable to control the primary display;
a band extending from the main body and configured to wrap around a wrist of a wearer;
a clasp coupled to the band and configured to secure the main body to the wrist of the wearer;
a secondary display proximate the clasp; and
a sensor proximate the clasp to detect a vital sign of the wearer, the sensor configured to communicate the vital sign to the processor.

2. The electronic timepiece of claim 1, wherein the secondary display is on the band.

3. The electronic timepiece of claim 1, wherein the secondary display is on the clasp.

4. The electronic timepiece of claim 1, wherein the sensor is in wireless communication with the processor.

5. The electronic timepiece of claim 1, wherein the sensor is hardwired to the processor through the band.

6. The electronic timepiece of claim 1, wherein the sensor is a CMOS-based module that generates a capacitive load to facilitate detection of the vital sign.

7. The electronic timepiece of claim 1, wherein the vital sign detected comprises at least one of a pulse, oxygen level, blood pressure, and perspiration.

8. The electronic timepiece of claim 1, further comprising:
at least one battery; and
at least one solar panel on the band, wherein the at least one solar panel is connected to the at least one battery.

9. The electronic timepiece of claim 1, further comprising a wireless transceiver in communication with the processor and configured to connect to a wireless network, the wireless transceiver configured to transceive information with a computing device.

10. The electronic timepiece of claim 1, further comprising a secondary sensor proximate the primary display, wherein the sensor proximate the clasp is configured to detect a vital sign with a first detection mode and the secondary sensor is configured to detect a vital sign with a second detection mode.

11. An electronic timepiece comprising:
a main body that includes a main face;
a processor within the main body and operable to control the electronic timepiece;
a band extending from the main body and configured to wrap around a wrist of a wearer;
a clasp coupled to the band and configured to secure the main body to the wrist of the wearer;
a first sensor located proximate the main body and configured to detect a vital sign of the wearer with a first detection mode; and
a second sensor located proximate the clasp and configured to detect a vital sign of the wearer with a second detection mode.

12. The electronic timepiece of claim 11, wherein the first detection mode is distinct from the second detection mode.

13. The electronic timepiece of claim 11, wherein the first detection mode and the second detection mode are identical.

14. The electronic timepiece of claim 11, wherein the first detection mode and the second detection mode comprise input values to the processor for calculation of a vital sign output.

15. The electronic timepiece of claim 11, wherein at least one of the first sensor and the second sensor are in wireless communication with the processor.

16. The electronic timepiece of claim 11, wherein at least one of the first sensor and the second sensor is hardwired to the processor through the band.

17. The electronic timepiece of claim 11, wherein the vital sign detected comprises at least one of a pulse, oxygen level, blood pressure, and perspiration.

18. The electronic timepiece of claim 11, further comprising:
at least one battery; and
at least one solar panel on the band, wherein the at least one solar panel is connected to the at least one battery.

19. The electronic timepiece of claim 11, further comprising a wireless transceiver in communication with the processor and configured to connect to a wireless network, the wireless transceiver configured to transceive information with a computing device.

20. The electronic timepiece of claim 11, further comprising a secondary display proximate the clasp.
